(19) United States
(12) Patent Application Publication
(10) Pub. No.: US 2014/0234947 A1
(43) Pub. Date: Aug. 21, 2014

(54) Treatment of Lignocellulosic Material

(71) Applicant: Roger Spencer Jones, Wales (GB)

(72) Inventor: Roger Spencer Jones, Wales (GB)

(73) Assignee: BIOFUELS WALES, LTD., Wales (GB)

(21) Appl. No.: 14/124,741

(22) PCT Filed: Jun. 6, 2012
(86) PCT No.: PCT/GB2012/000492

§ 371 Date: Apr. 25, 2014

(30) Foreign Application Priority Data
Jun. 9, 2011 (GB) 1109639.3
Jan. 12, 2012 (GB) 1200489.1

(51) Int. Cl. B01J 19/12; A23N 17/00; D21C 5/00; A23K 1/00

(52) U.S. Cl. CPC B01J 19/126; A23K 1/001; A23N 17/004; D21C 5/005; B01J 2219/1206
USPC 435/277; 426/237; 426/48; 426/635; 99/451; 44/605; 422/186.03

(57) ABSTRACT

Method and apparatus for making biofuels such as biodiesel and bioethanol or animal foodstuff by treating lignocellulosic material by subjecting the material to microwave radiation at the resonant frequency of the lignin to dissociate the lignin.

This invention relates to the treatment of biomass comprising lignocellulosic material, and, more particularly, to the breaking down of lignin associated with cellulose. The treatment may have particular application in the manufacture of biofuels, animal feedstuffs and other products.

Miscanthus is a perennial grass with a high lignin content. Without costly processing, it is not useful as an animal feedstuff, and animals cannot digest the lignin, which also blocks access to the cellulose. Its principal use in connection with animals is as a bedding material. Nor is it of much use as a fuel, except it can be burned in its raw, but dried state, which is wasteful and not always convenient.

Various ways of overcoming the problem of dissociating lignin have been proposed, usually in connection with the production of biofuels, including pyrolysis, digestion, using enzymes, and torrefaction, including microwave torrefaction. Some processes produce solid fuels, some liquid fuels, with varying yields, but none has shown such promise that it has been widely adopted commercially.

In lignocellulose, lignin is present as a crust around a cellulose core, itself comprising a skeleton of cellulose chains embedded in a cross-linked matrix of hemicellulose.

Cellulose is a homopolymer of β-D-glucose units linked via β-1-4 glycosidic bonds. The basic repeat unit of cellulose is cellobiose which consists of two glucose molecules. The β-1-4 bonds result in the formation of a linear chain of glucose molecules. This linearity results in an ordered packing of cellulose chains that interact via intermolecular and intramolecular hydrogen bonds involving hydroxyl groups and hydrogen atoms of neighbouring glucose units. Consequently, cellulose exists as crystalline fibres with occasional amorphous regions. The crystallinity of cellulose fibres is a major hurdle for efficient enzymatic hydrolysis.

Hemicelluloses are heteropolymers made up of five-carbon sugars such as xylose and arabinose, and six-carbon sugars such as galactose and mannose. Their structure and composition can vary. Grasses such as switchgrass (Panicum virgatum) contain two types of hemicelluloses. The major hemicellulose is arabinoxylan, which consists of a xylan backbone made up of β-1-4 linked D-xylose units with frequent arabinose side chains, which minimise hydrogen bonding. Hemicellulose has, as a result, low crystallinity. The minor hemicellulose is glucomannan, which is a copolymeric chain of glucose and mannose units. Occasional branching in glucomannan also contributes to the low crystallinity of hemicellulose.

Lignin is a highly complex polymer made up of three types of phenolic acids: p-coumaryl alcohol, coniferyl alcohol and synapyl alcohol, which are known as monolignols. Their proportions vary depending on the type of lignocellulosic material. In general, grasses such as switchgrass typically contain equal amounts of all three monolignols. Carbon-carbon and other bonds between individual monolignols result in the formation of dimers, trimers and tetramers that form random linkages with each other resulting in the complex structure of lignin. The carbon-carbon bonds are the strongest and are primarily responsible for the barrier nature of lignin.

The complex ‘crust’ structure may be thought of, for present purposes, as a coil surrounding the cellulosic core. The structure will have a resonant frequency, which is found to be in the microwave band.

The present invention provides novel ways of treating lignocellulosic materials and of producing useful materials from lignocellulose that have high yields and low energy requirements.

The invention comprises a method for treating lignocellulosic material comprising subjecting the material to microwave radiation at the resonant frequency of the lignin to dissociate the lignin.

The resonant frequency of the lignin in a sample of material to be treated may be ascertained in a preliminary step. The sample is placed in a chamber into which microwave power is injected over a range of frequencies that includes the anticipated resonant frequency. The microwave radiation passing through the chamber is measured and the frequency or frequencies noted at which the microwave energy is absorbed in the chamber.

The measured resonant frequency may be used to select a suitable processing unit, one having a chamber and associated microwave generator means to inject microwaves at the resonant frequency into the chamber, or to set up a processing unit comprising a chamber and a tunable source of microwave radiation so that radiation from the source is injected at the resonant frequency.

While material to be processed, derived from a single source, will be more or less uniform, it is to be anticipated that, in a continuous operation, the properties of the material will vary to some extent, so that the resonant frequency of material passing through the chamber will vary over time. The material may be subjected to microwave radiation over a range of frequencies that includes frequencies at which the material is expected to resonate.

It may, however, be arranged that the chamber is monitored to measure the instantaneous resonant frequency and control the microwave generator to inject that frequency. The resonant frequency may be ascertained by monitoring the microwave power that passes through the chamber, resonance occurring when microwave power is most strongly absorbed.

Microwave generation may be under the control of a feedback system adapted to maintain microwave output power at a minimum. One type of controller that may be used is a proportional-integral-derivative, or PID, controller in which a manipulated variable, the output of the controller, is controlled with reference to a proportional error, an integral error and a derivative error.

A frequency of around 2.473 GHz is found to break down lignin from some lignocellulose without affecting the associated cellulose or hemicellulose. Frequencies for lignocellulose from different sources will be close to this frequency.

The radiation may be applied under conditions such as to encourage, or at least not discourage, the generation of ozone during the dissociation. Ozone helps further to break down the double bonds that are characteristic of lignin.

Ozone may be generated by a UV lamp arrangement. The UV lamp may be a low-pressure plasma lamp, excited by microwave radiation. The lamp may be contained in a chamber fed with air with an ozonised air output to the plasma treatment chamber.

The process may further be carried out under conditions that do not encourage, or that discourage, the generation of acids during the dissociation.

Following the irradiation, the treated material may be subjected to a further treatment to convert it to a foodstuff. The further treatment may comprise an enzyme treatment or fermentation. For such treatment, it is important that the enzyme or microorganism is not attacked by acids. The lignin breakdown is preferably carried out under such conditions that enzyme-attacking or microorganism-attacking acids, which may comprise carrying out the breakdown at low temperature, such as at of below 250° C., preferably below 100° C.

Examples of material that comprise lignocellulose that may be treated according to the invention include grass, particularly switchgrass, and wood, for example, willow. The materials may be prepared for treatments by comminution to a size at which they can be easily introduced into a treatment chamber.

The invention also comprises apparatus for treating lignocellulosic material, comprising microwave generating means for subjecting the material to microwave radiation at the resonant frequency of the lignin to dissociate the lignin.

The frequency may also be such as does not dissociate the glucose core of the lignocellulose material.

The microwave generating means may be a magnetron, and the apparatus may comprise transmission means adapted to transmit the microwaves generated thereby to a treatment chamber. The transmission means may include waveguide means. The arrangement may be tunable to deliver microwaves at a given frequency into the chamber, and may have a feedback arrangement marinating the microwave frequency at the resonant frequency of the lignin.

The feedback arrangement may comprise sensor means adapted to sense when maximum power is being absorbed in the chamber. The sensor means may comprise temperature measuring means measuring the temperature in the chamber.

The feedback arrangement may comprise a PID control arrangement.

The apparatus may also comprise ozonising means. Such ozonising means may comprise a UV lamp, which may be a low pressure plasma lamp excited by microwave radiation. Ozone-rich air may be generated in or supplied into the treatment chamber.

The invention also comprises a product made from lignocellulose subjected to microwave radiation at the resonant frequency of the lignin to dissociate the lignin. The product may be a biofuel such as bioethanol or biodiesel, or an animal feedstuff such as oilcake.

Methods according to the invention for making a foodstuff by treating lignocellulose material will now be described with reference to the accompanying drawings, in which:

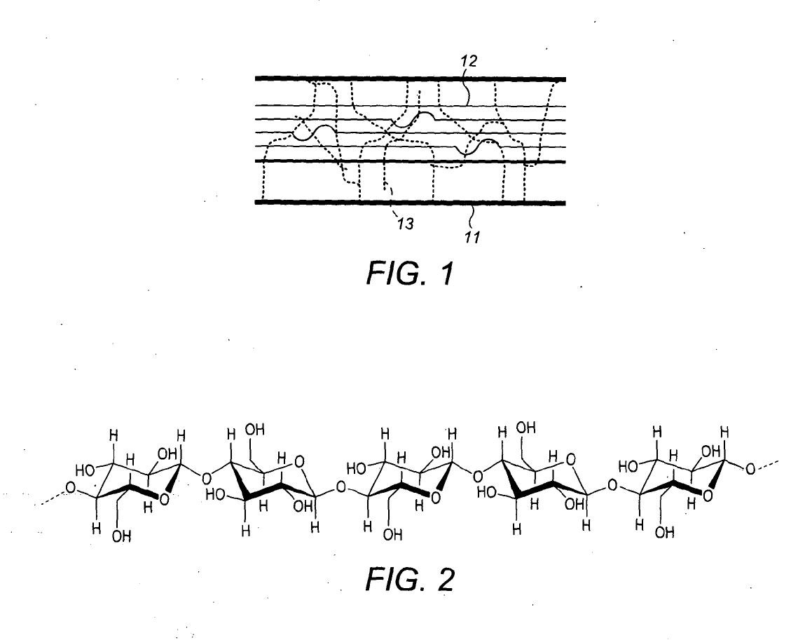

FIG. 1 is a representation of a lignocellulose structure:

FIG. 2 is a representation of a cellulose chain;

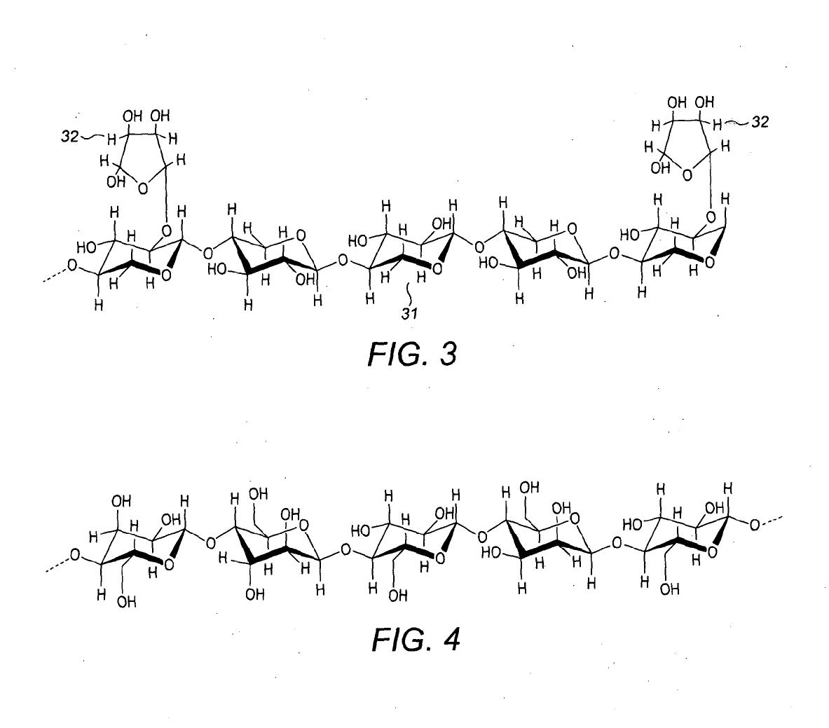

FIG. 3 is a representation of arabinoxylan;

FIG. 4 is a representation of glucomannan;

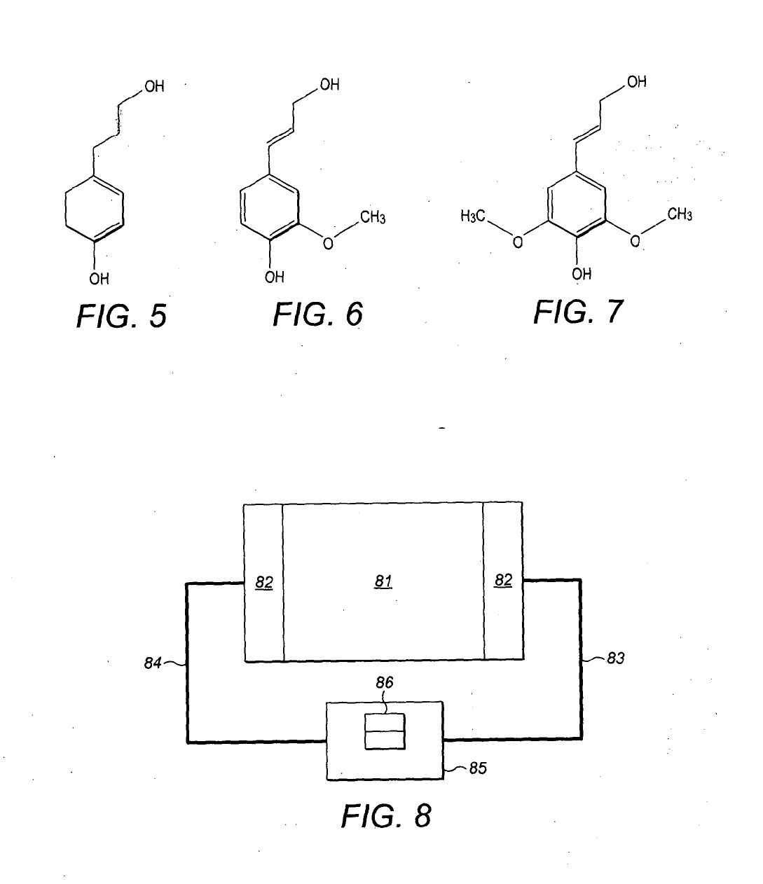

FIG. 5 is a representation of p-coumaryl alcohol;

FIG. 6 is a representation of coniferyl alcohol;

FIG. 7 is a representation of sinapyl alcohol;

FIG. 8 is a diagrammatic view of a test microwave cavity resonator set-up for determining dielectric constant and resonance;

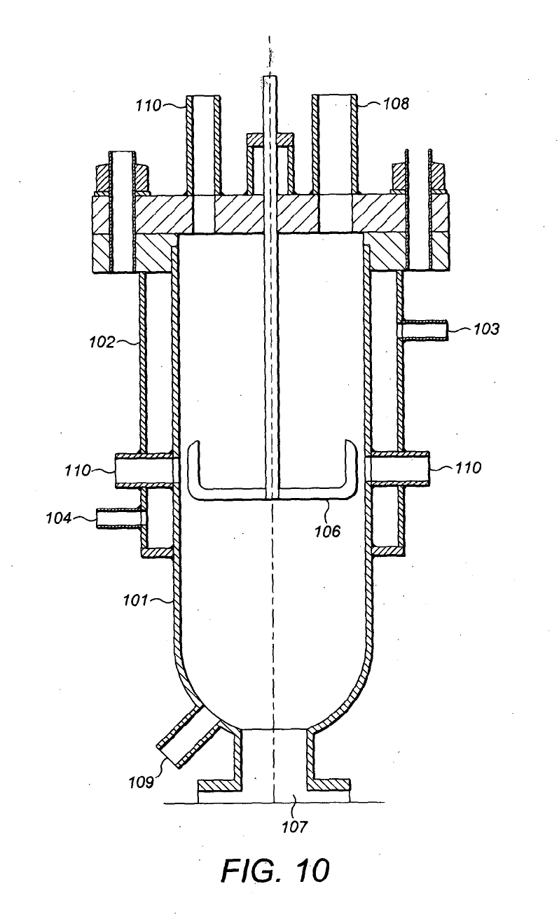

FIG. 10 is a section through a reactor;

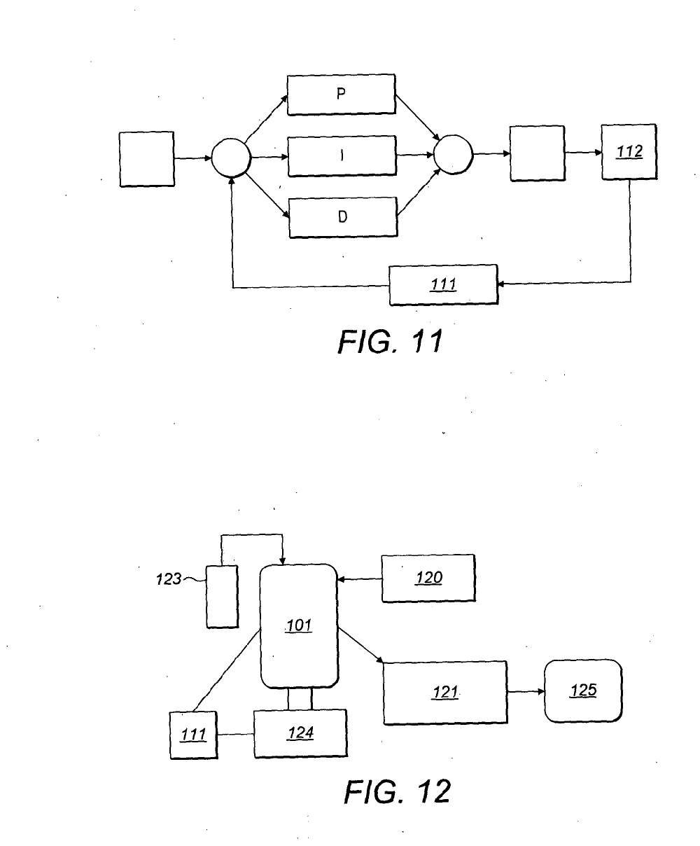

FIG. 11 is a diagrammatic illustration of a PID controller; and

FIG. 12 is a block diagram of a biofuel or foodstuff production system.

The drawings illustrate a method for treating lignocellulosic material, comprising subjecting the material to microwave radiation at the resonant frequency of the lignin to dissociate the lignin.

FIG. 1 is a representation of lignocellulose, showing the lignin 11 present as a crust around a cellulose core 12, itself comprising a skeleton of cellulose chains embedded in a cross-linked matrix of hemicellulose.

Cellulose, shown in FIG. 2, is a homopolymer of β-D-glucose units linked via β-1-4 glycosidic bonds. The basic repeat unit of cellulose is cellobiose which consists of two glucose molecules. The β-1-4 bonds result in the formation of a linear chain of glucose molecules. This linearity results in an ordered packing of cellulose chains that interact via intermolecular and intramolecular hydrogen bonds involving hydroxyl groups and hydrogen atoms of neighbouring glucose units. Consequently, cellulose exists as crystalline fibres with occasional amorphous regions. The crystallinity of cellulose fibres is a major hurdle for efficient enzymatic hydrolysis.

Hemicelluloses are heteropolymers made up of five-carbon sugars such as xylose and arabinose, and six-carbon sugars such as galactose and mannose. Their structure and composition can vary. Grasses such as switchgrass (Panicum virgatum) contain two types of hemicelluloses. The major hemicellulose is arabinoxylan, FIG. 3, which consists of a xylan backbone 31 made up of β-1-4 linked D-xylose units with frequent arabinose side chains, 32, which minimise hydrogen bonding. Hemicellulose has, as a result, low crystallinity. The minor hemicellulose is glucomannan, FIG. 4, which is a copolymeric chain of glucose and mannose units. Occasional branching in glucomannan also contributes to the low crystallinity of hemicellulose.

Lignin is a highly complex polymer made up of three types of phenolic acids: p-coumaryl alcohol (FIG. 5), coniferyl alcohol (FIG. 6) and synapyl alcohol (FIG. 7), which are known as monolignols. Their proportions vary depending on the type of lignocellulosic material. In general, grasses such as switchgrass typically contain equal amounts of all three monolignols. Carbon-carbon and other bonds between individual monolignols result in the formation of dimers, timers and tetramers that form random linkages with each other resulting in the complex structure of lignin. The carbon-carbon bonds are the strongest and are primarily responsible for the barrier nature of lignin.

The complex ‘crust’ structure may be thought of, for present purposes, as a coil surrounding the cellulosic core. The structure will have a resonant frequency, which is found to be in the microwave band.

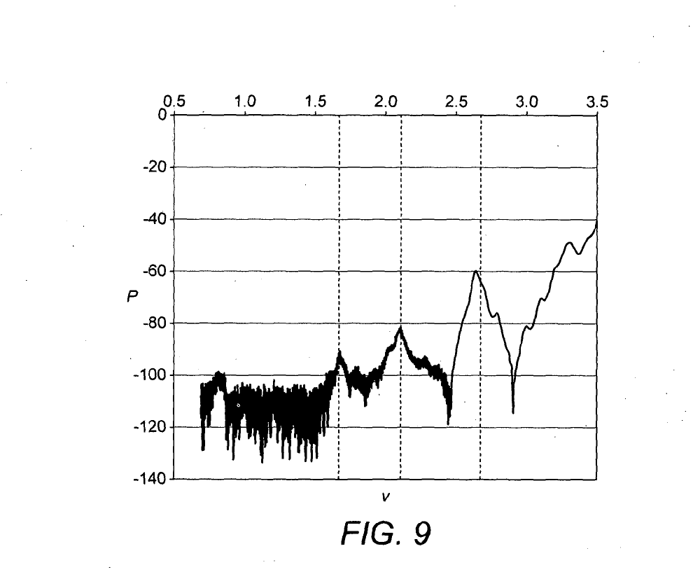

The resonant frequency can be determined using a test arrangement as shown in FIG. 8 comprising a microwave cavity 81 that can be filled with test material with microwave launchers 82—coaxial cable to waveguide transitions—attached to end apertures of the cavity 81. Coaxial cables 83, 84 connect the cavity 81 to a microwave generator/analyser 85. The input frequency is swept, and the output power displayed on a screen 86. FIG. 9 shows a typical display showing power P dBm against frequency v in GHz with peaks at three Transverse Electrical Modes.

The reactor illustrated in FIG. 10 comprises a stainless steel reactor chamber 101 with a cooling jacket 102 with inlet and outlet 103, 104 for cooling water. A stirrer 106 is provided in the chamber 101. A microwave window 107 is located in the bottom of the chamber 101 closed with a plug of PEEK or PTFE. Inlet 108 and outlet 109 ports are provided for introduction of material to be processed and removal of product, and various sensor ports 1110 for temperature, ultrasound and pressure sensors. The reactor chamber sits above a waveguide, not shown in this Figure, connected to a microwave cavity resonator which is tunable to deliver microwave energy at a frequency within a range predetermined for example by a test set up as illustrated in FIG. 8.

FIG. 11 illustrates a control arrangement for a microwave oscillator feeding microwave energy into the chamber 101 of FIG. 10. This is a PID—Proportional-Integral-Differential—controller, which calculates an error value as the difference between a measured process variable and a set point, and makes adjustments based on a term proportional to the measured error, a term dependent on accumulated past errors and a term depending on the rate of change of the variable. It is a widely used and well-understood feedback control arrangement that is found to be particularly appropriate to controlling the microwave breakdown of lignin in lignocellulose. A sensor 111 senses a variable in the microwave chamber 112 and inputs the value to an interface 113 into which the set point value 114 is fed. The error signal is fed to the P, I and D units, which collectively influence an interface feeding a value to the microwave generator. The error signal indicative of absorption of microwave energy may be a temperature or pressure signal. A temperature may be measured by measuring the velocity of sound in the chamber from an ultrasound signal input e.g. from a piezo-electric transducer.

In this way, the microwave frequency is controlled to give peak absorption of microwave power in the chamber at the resonant frequency of the lignin, whereby to effect dissociation of the lignin without also disrupting the cellulose and hemicellulose elements.

UV radiation can be introduced by a microwave-excited plasma lamp placed inside the chamber 101 or outside it, shining in, or in a separate chamber through which air passes into the chamber, so as to generate ozone in the chamber or introduce it. Ozone helps to break down the lignin.

FIG. 12 illustrates the processing of lignocellulose through to a biofuel such as biodiesel or bioethanol or an oil from which a foodstuff such as oilcake can be made

Lignocellulose suitably comminuted is introduced from a store 120, where it may be maintained under controlled atmospheric conditions to be substantially free of moisture, into the reactor chamber 101. Ozonised air from a UV chamber 121 is also fed into the chamber 101, which sits atop a microwave generator 124 controlled by PID controller 111. Broken down lignocellulose from reactor 101 is transferred to a fermentation or enzyme treatment plant 121 from which a biofuel or oil from which foodstuff can be made is delivered to a store 125.

The apparatus shown in FIG. 12 is suitable for the batch processing of many lignocellulose materials, including miscanthus, switchgrass, meadow hay, willow and other fast-growing crops into a foodstuff. The product from the reactor 101 has substantially all lignin broken down, while the cellulose and hemicellulose core is left intact, and is substantially free of acids and other compounds that are destructive of the microorganisms or enzymes used in the biofuel or foodstuff production stage. The eventual foodstuff product may comprise oilcake that can be further processed into a variety of animal foodstuffs.

The process can also be configured as a continuous process.

1. A method for treating lignocellulosic material, comprising subjecting the material to microwave radiation at the resonant frequency of the lignin to dissociate the lignin.

2. A method according to claim 1, in which the material is subjected to microwave radiation over a range of frequencies.

3. A method according to claim 1, comprising measuring the absorption of the applied radiation.

4. A method according to claim 3, in which irradiation is ceased when measurement of the absorption indicated that a desired amount of lignin, or all present, has been dissociated.

5. A method according to claim 1, in which the radiation is applied under conditions such as to encourage, or at least not discourage, the generation of ozone during the dissociation.

6. A method according to claim 1, in which ozone is separately generated and added to the reaction.

7. A method according to claim 1, in which the treatment is carried out under conditions that do not encourage, or that discourage, the generation of acids and other compounds destructive of microorganisms and enzymes used in biofuel or foodstuff production.

8. A method according to claim 1, in which the treated material is further subjected to another treatment to convert it to a foodstuff such as biofuel or oil from which oilcake and other foodstuff products can be made.

9. A method according to claim 8, in which the other treatment comprises fermentation or an enzyme treatment.

10. Apparatus for treating lignocellulosic material, comprising microwave generating means for subjecting the material to microwave radiation at the resonant frequency of the lignin to dissociate the lignin.

11. Apparatus according to claim 10, in which the frequency is also such as does not dissociate the glucose core of the lignocellulose material.

12. Apparatus according to claim 10, in which the microwave generating means comprise a magnetron, and the apparatus comprises transmission means adapted to transmit the microwaves generated thereby to a treatment chamber.

13. Apparatus according to claim 12, in which the transmission means include waveguide means.

14. Apparatus according to claim 10, which is tunable to deliver microwaves at a given frequency into the chamber, and has a feedback arrangement marinating the microwave frequency at the resonant frequency of the lignin.

15. Apparatus according to claim 14, in which the feedback arrangement comprises sensor means adapted to sense when maximum power is being absorbed in the chamber.

16. Apparatus according to claim 15, in which the sensor means comprise temperature measuring means measuring the temperature in the chamber.

17. Apparatus according to claim 15, in which the feedback arrangement comprises a PID control arrangement.

18. Apparatus according claim 1, also comprising ozonising means.

19. Apparatus according to claim 18, in which the ozonising means comprise a UV lamp, which may be a low pressure plasma lamp excited by microwave radiation, generating zone-rich air in or supplying it to the treatment chamber.

20. Biofuel or animal foodstuff such as oilcake produced by an apparatus according to claim 10.
